(19) United States
(12) Patent Application Publication
(10) Pub. No.: US 2014/0247007 A1
(43) Pub. Date: Sep. 4, 2014

(54) Inductive Power Transfer System and Transmitting and Receiving Devices Thereof

(71) Applicants: KO-TING LIAO, New Taipei City (TW); TZONG-DAR WU, Taoyuan County (TW); JU-CHIAO CHANG, New Taipei City (TW)

(72) Inventors: KO-TING LIAO, New Taipei City (TW); TZONG-DAR WU, Taoyuan County (TW); JU-CHIAO CHANG, New Taipei City (TW)

(73) Assignee: LUXX LIGHTING TECHNOLOGY (TAIWAN) LTD., TAOYUAN COUNTY (TW)

(21) Appl. No.: 14/193,016

(22) Filed: Feb. 28, 2014

(30) Foreign Application Priority Data
Mar. 1, 2013 (TW) 102107304

(51) Int. Cl. H01F 38/14; H02J 7/02

(52) U.S. Cl. CPC H01F 38/14; H02J 7/025
USPC 320/108; 307/104

(57) ABSTRACT

A contactless power transfer system can respectively connect multiple conductive coils in parallel between the power source circuit of a transmitting device and the electric load of a receiving device, and can wind the conductive coils in successively alternating directions. Advantages of the contactless power transfer system include the ability to prevent issues related to overheating and excessive power voltages on the conductive coils, which may occur in applications requiring greater working distances between the energizing coil assemblies.

### CROSS-REFERENCE TO RELATED APPLICATION

This application claims priority to Taiwan Patent Application No. 102107304 filed on Mar. 1, 2013, which is incorporated herein by reference.

### BACKGROUND

1. Field of the Invention

The present invention relates to inductive power transfer systems.

2. Description of the Related Art

Electric appliances are widely present in modern living surroundings. While cable connection is conventionally used to power electric appliances of bigger sizes (such as desktop computers, television sets and the like), battery cells may be used for small and portable devices such as mobile phones, portable media players, wireless pointing devices and the like.

In order to facilitate access to the electric power in a safe manner, one known approach consists in transferring electric power “wirelessly” (i.e., without physical contact between connection electrodes) through inductive coupling between conductive coils. In such systems, a first coil wound around a first magnet can be connected with a power supply, and a second coil wound around a second magnet can be connected with an electric load, each of the first and second coils being formed as a single spiral. When a voltage bias is applied between two ends of the first coil, a varying current can flow through the first coil, and inductive coupling between the first and second coils can result in another electric current flowing through the second coil. As a result, a voltage bias can be created between two ends of the second coil to power the electric load.

In the aforementioned system using induction coils, the working distance between the first and second coils is usually a function of the number of turns in the first and second coils and the lengths of the first and second magnets. In particular, the relationship is such that increasing the number of turns in the first and second coils and the lengths of the first and second magnets can allow a greater working distance between the first and second coils. However, an increase of the voltage bias at the resonant circuit and the first coil may cause overheating problems. For example, in the case of a working distance equal to 50 mm and a power transfer of 5 Watts, the voltage bias on the first coil has to be higher than 400V, which may cause overheating to a relatively high temperature, typically above 80 degrees Celsius. The high voltage bias and overheating issues may raise safety concerns, and also affect the service life of the system.

Therefore, there is a need for a power transfer system that can allow greater working distances, and can address at least the foregoing issues.

### SUMMARY

The present application describes a contactless power transfer system, and transmitting and receiving devices thereof. In one embodiment, a transmitting device for transferring power to a receiving device through inductive coupling is described. The transmitting device includes a power source circuit having a first and a second connection node, a first conductive coil having a first and a second end, and a second conductive coil arranged near the first conductive coil and having a third and a fourth end. The first and third ends are electrically connected with the first connection node, and the second and fourth ends are electrically connected the second connection node, the first and third ends and the first connection node being respectively applied with a same first voltage, and the second and fourth ends and the second connection node are respectively applied with a same second voltage.

In another embodiment, a receiving device for receiving power from a transmitting device through inductive coupling is described. The receiving device includes an electric load having a first and a second connection node, a first conductive coil having a first and a second end, and a second conductive coil arranged near the first conductive coil and having a third and a fourth end. The first and third ends are electrically connected with the first connection node, and the second and fourth ends are electrically connected the second connection node, the first and third ends and the first connection node being respectively applied with a same first voltage, and the second and fourth ends and the second connection node are respectively applied with a same second voltage.

In yet another embodiment, a power transfer system suitable to transfer power through inductive coupling is described. The power transfer system includes a power source circuit having a first and a second connection node, a first energizing coil assembly including a first and a second conductive coil connected between the first and second connection node of the power source circuit, an electric load having a third and a fourth connection node, and a second energizing coil assembly including a third and a fourth conductive coil connected between the third and fourth connection node of the electric load. The first conductive coil has a first and a second end, the second conductive coil has a third and a fourth end, the first and third ends are electrically connected with the first connection node, and the second and fourth ends are electrically connected the second connection node, the first and third ends and the first connection node being respectively applied with a same first voltage, and the second and fourth ends and the second connection node being respectively applied with a same second voltage. The third and fourth conductive coils are respectively coupled inductively with the first and second conductive coils, the third conductive coil having a fifth and a sixth end, the fourth conductive coil having a seventh and an eighth end. The fifth and seventh ends are electrically connected with the third connection node, and the sixth and eighth ends are electrically connected the fourth connection node, the fifth and seventh ends and the third connection node being respectively applied with a same third voltage, and the sixth and eighth ends and the fourth connection node being respectively applied with a same fourth voltage. The first and second energizing coil assemblies can be thereby inductively coupled with each other to supply power to the electric load.

At least one advantage of the systems described herein is the ability to overcome the high voltage bias and overheating issues that may arise when the working distance increases.

### BRIEF DESCRIPTION OF THE DRAWINGS

FIG. 1 is a schematic view illustrating an embodiment of a contactless power transfer system;

FIG. 2 is a schematic view illustrating an arrangement of the power transfer system;

FIG. 3A is a schematic view illustrating an embodiment in which the contactless power transfer system is implemented for powering an electronic device used in a building window structure;

FIG. 3B is a schematic view illustrating another example of implementation of the contactless power transfer system in a building structure; and

FIG. 4 is a schematic view illustrating an embodiment in which the contactless power transfer system is implemented in a power charging application.

### DETAILED DESCRIPTION OF THE EMBODIMENTS

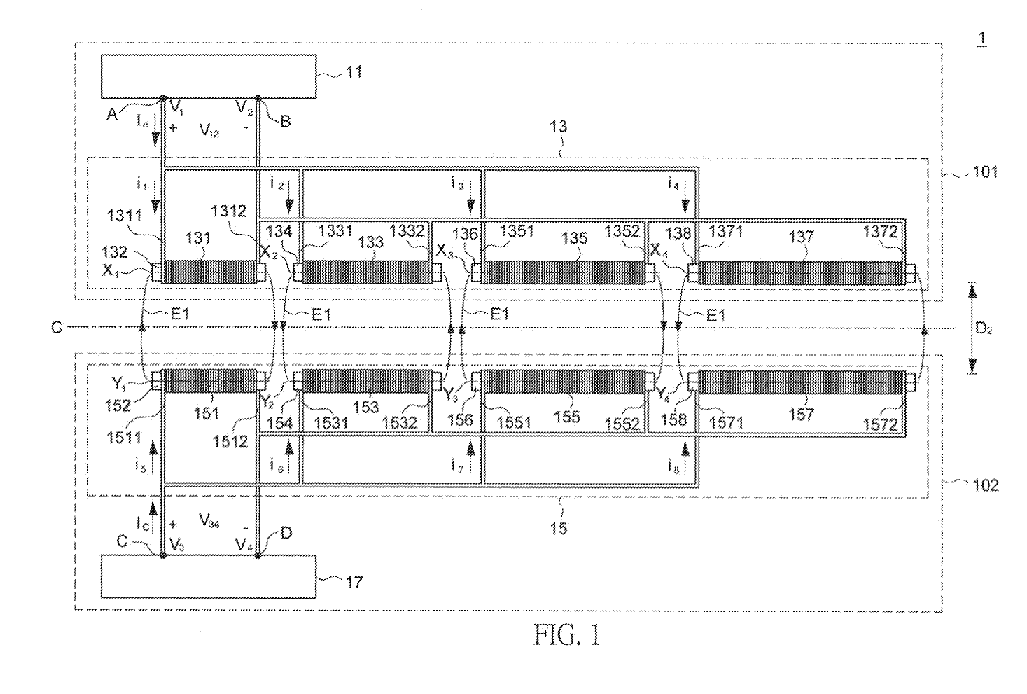

FIG. 1 is a schematic view illustrating an embodiment of a contactless power transfer system 1. The term “contactless” as used herein means that the power transfer system can transfer power from a transmitting device to a receiving device without physical contact between conductive electrodes. The power transfer system 1 can include a transmitting device 101 and a receiving device 102. The transmitting device 101 can transfer power to the receiving device 102 through inductive coupling. The transmitting device 101 can include a power source circuit 11 and an energizing coil assembly 13. The receiving device 102 can include an energizing coil assembly 15 and an electric load 17. The two energizing coil assemblies 13 and 15 may be arranged approximately symmetric at two sides of a lengthwise axis C. The power source circuit 11 can transfer power to the electric load 17 through inductive coupling between the two energizing coil assemblies 13 and 15.

The energizing coil assembly 13 can include a plurality of conductive coils 131, 133, 135 and 137. It is worth noting that there is no limitation to the quantity of the conductive coils, which may be 2, 3, 4, 5 or higher. The conductive coils 131, 133, 135 and 137 can be arranged linearly and spaced apart from one another, and can respectively wind around axes X₁, X₂, X₃ and X₄. In one embodiment, each of the conductive coils may be formed by a single conductor wire wound around the corresponding axis. The axes X₁, X₂, X₃ and X₄ can be coaxially aligned with a common first axis. Two mutually adjacent conductive coils (e.g., the conductive coils 131 and 133, the conductive coils 133 and 135, or the conductive coils 135 and 137) can wind in opposite directions around their respective axes. For example, the conductive coil 131 can wind around the axis X₁ in a first direction, the conductive coil 133 can wind around the axis X₂ in a second direction opposite to the first direction, the conductive coil 135 can wind around the axis X₃ in the first direction, and the conductive coil 137 can wind around the axis X₄ in the second direction. Accordingly, the conductive coils 131, 133, 135 and 137 can be linearly aligned about the same first axis, and the direction of winding the conductive coils 131, 133, 135 and 137 can alternate along the first axis.

The power source circuit 11 can have two connection nodes A and B, the connection node A having a voltage V₁, and the connection node B having another voltage V₂ different from the voltage V₁. Each of the conductive coils 131, 133, 135 and 137 can have two ends: a first end is directly connected with the connection node A, and a second end is directly connected with the connection node B. For example, the conductive coil 131 can have two ends 1311 and 1312, the conductive coil 133 can have two ends 1331 and 1332, the conductive coil 135 can have two ends 1351 and 1352, and the conductive coil 137 can have two ends 1371 and 1372. The ends 1311, 1331, 1351 and 1371 (which can exemplary be current input ends of the conductive coils 131, 133, 135 and 137) can be respectively connected with the connection node A and have the same voltage V₁. The ends 1312, 1332, 1352 and 1372 (which can exemplary be current output ends of the conductive coils 131, 133, 135 and 137) can be respectively connected with the connection node B and have the same voltage V₂. The conductive coils 131, 133, 135 and 137 can be thereby connected in parallel between the two connection nodes A and B of the power source circuit 11.

Likewise, the energizing coil assembly 15 can include a plurality of conductive coils 151, 153, 155 and 157. The conductive coils 151, 153, 155 and 157 can be arranged linearly and spaced apart from one another, and can respectively wind around axes Y₁, Y₂, Y₃ and Y₄. The axes Y₁, Y₂, Y₃ and Y₄ can be coaxially aligned with a common second axis that is substantially parallel to and offset from the first axis to which the axes X₁, X₂, X₃ and X₄ are aligned. Two mutually adjacent conductive coils (e.g., the conductive coils 151 and 153, the conductive coils 153 and 155, or the conductive coils 155 and 157) can wind in opposite directions around their respective axes. For example, the conductive coil 151 can wind around the axis Y₁ in the second direction, the conductive coil 153 can wind around the axis Y₂ in the first direction opposite to the second direction, the conductive coil 155 can wind around the axis Y₃ in the second direction, and the conductive coil 157 can wind around the axis Y₄ in the first direction. Accordingly, the conductive coils 151, 153, 155 and 157 can be linearly aligned with the same second axis, and the direction of winding the conductive coils 151, 153, 155 and 157 can alternate along the second axis.

The electric load 17 can have two connection nodes C and D. Each of the conductive coils 151, 153, 155 and 157 can have two ends: a first end is directly connected with the connection node C, and a second end is directly connected with the connection node D. For example, the conductive coil 151 can have two ends 1511 and 1512, the conductive coil 153 can have two ends 1531 and 1532, the conductive coil 155 can have two ends 1551 and 1552, and the conductive coil 157 can have two ends 1571 and 1572. The ends 1511, 1531, 1551 and 1571 (which can exemplary be current input ends of the conductive coils 151, 153, 155 and 157) can be respectively connected with the connection node C and have a same voltage V₃. The ends 1512, 1532, 1552 and 1572 (which can exemplary be current output ends of the conductive coils 151, 153, 155 and 157) can be respectively connected with the connection node D and have a same voltage V₄. The conductive coils 151, 153, 155 and 157 can be thereby connected in parallel between the two connection nodes C and D of the electric load 17.

With the aforementioned arrangement, the conductive coils 131, 133, 135 and 137 are respectively symmetric to the conductive coils 151, 153, 155 and 157 about the axis C. Accordingly, the electromagnetic fields E1 respectively generated between each pair of the conductive coils can be distributed in a same plane.

A working distance D₂ can be defined as the gap or distance separating the two energizing coil assemblies 13 and 15 subjected to inductive coupling (D2 may be taken between the two axes of the energizing coil assemblies 13 and 15). Owing to their parallel connection with the power source circuit 11, the conductive coils 131, 133, 135 and 137 can be respectively applied with a same stable voltage bias V₁₂=V₁-V₂ occurring between the connection nodes A and B. This parallel connection of the conductive coils 131, 133, 135 and 137 can reduce the impact that a variation in the working distance D₂ may have on the voltage bias at the conductive coils. For example, suppose the power source circuit 11 delivers power of 5 Watts and the working distance D₂ is 50 mm, the voltage bias at the conductive coils 131, 133, 135 and 137 can be smaller than 200V. Therefore, the working distance D₂ between the two energizing coil assemblies 13 and 15 may be desirably increased according to the application needs.

When the power source circuit 11 outputs a timely varying electric current Iₐ at the connection node A, the electric current Iₐ can split into multiple currents i₁, i₂, i₃ and i₄ (Iₐ=i₁+i₂+i₃+i₄) that respectively flow through the conductive coils 131, 133, 135 and 137 to generate electromagnetic fields. Because the conductive coils 131, 133, 135 and 137 wind in successively alternating directions, the corresponding electromagnetic fields also alternate in directions and the mutually adjacent ends of each pair of neighboring conductive coils (e.g., the ends 1312 and 1331 of the conductive coils 131 and 133, the ends 1332 and 1351 of the conductive coils 133 and 135, and so forth) can have a same polarity. In this manner, no magnetic attraction is generated between the successive conductive coils 131, 133, 135 and 137, which can be accordingly disposed separate from one another.

At an effective working distance D₂, the flow of the electric currents i₁, i₂, i₃ and i₄ through the conductive coils 131, 133, 135 and 137 can produce inductive coupling that generates induction currents i₅, i₆, i₇ and i₈ respectively flowing through the conductive coils 151, 153, 155 and 157. The induction currents i₅, i₆, i₇ and i₈ can merge to form an electric current I_{c} (I_{c}=i₅+i₆+i₇+i₈) flowing through the electric load 17. As a result, the connection nodes C and D of the electric load 17 can respectively have the voltage V₃ and V₄.

Owing to their parallel connection with the electric load 17, the conductive coils 151, 153, 155 and 157 can be respectively applied with a same stable voltage bias V₃₄=V₃-V₄ occurring between the connection nodes C and D. Moreover, because the conductive coils 151, 153, 155 and 157 wind in successively alternating directions, the corresponding electromagnetic fields can alternate in directions and the mutually adjacent ends of each pair of neighboring conductive coils (e.g., the ends 1512 and 1531 of the conductive coils 151 and 153, the ends 1532 and 1551 of the conductive coils 153 and 155, and so forth) can have inverse polarity. In this manner, no magnetic attraction is generated between the successive conductive coils 151, 153, 155 and 157, which can be accordingly disposed separate from one another.

According to one embodiment, the conductive coils 131, 133, 135 and 137 can further respectively wind around spaced-apart magnetic conductors 132, 134, 136 and 138 to increase the inductance of the energizing coil assembly 13. Examples of the magnetic conductors 132, 134, 136 and 138 can include, without limitation, ferrite cores. Since the conductive coils 131, 133, 135 and 137 wind in successively alternating directions, the magnetic conductors 132, 134, 136 and 138 can have successively alternating magnetic field directions, and the mutually adjacent ends of the magnetic conductors can have inverse polarity. Accordingly, no magnetic attraction occurs between the magnetic conductors 132, 134, 136 and 138, which can be disposed separate from one another.

Likewise, the conductive coils 151, 153, 155 and 157 can also respectively wind around spaced-apart magnetic conductors 152, 154, 156 and 158 (e.g., ferrite cores) to increase the inductance of the energizing coil assembly 15. Since the conductive coils 151, 153, 155 and 157 wind in successively alternating directions, the magnetic conductors 152, 154, 156 and 158 can have successively alternating magnetic field directions, and the mutually adjacent ends of the magnetic conductors can have inverse polarity. Accordingly, no magnetic attraction occurs between the magnetic conductors 152, 154, 156 and 158, which can be disposed separate from one another.

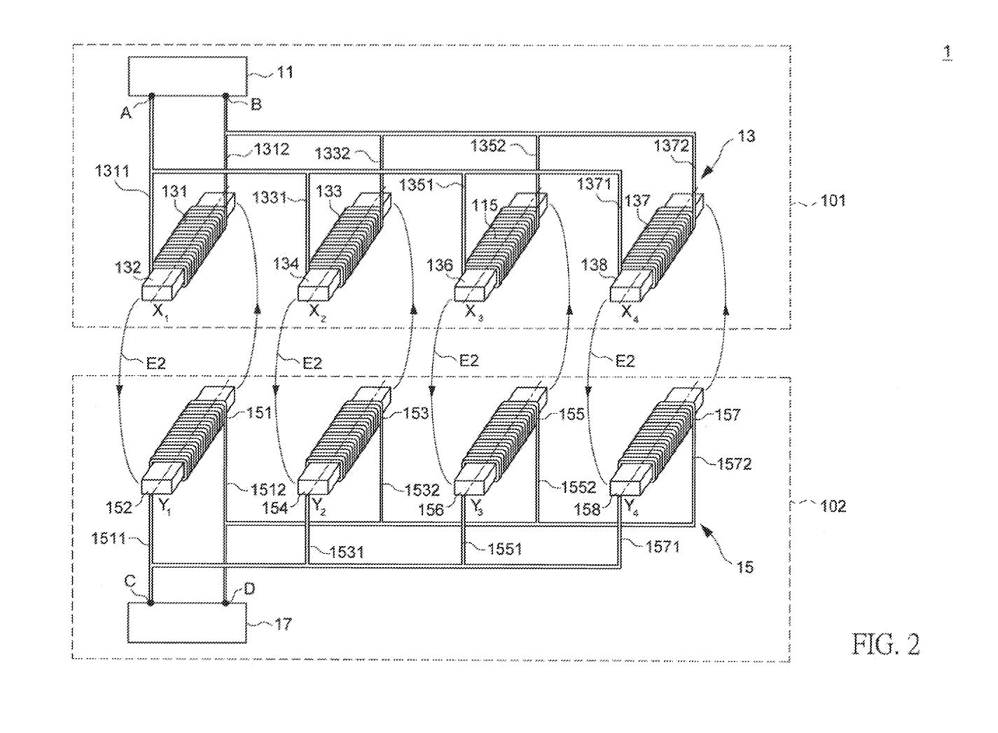

It is worth noting that the same circuit connections and coil winding configurations described previously may be applied with different spatial arrangements of the conductive coils. FIG. 1 illustrates an arrangement in which the conductive coils in the transmitting device (and receiving device) are positioned linearly aligned. FIG. 2 is a schematic view illustrating another possible arrangement for the conductive coils different from that of FIG. 1. In the energizing coil assembly 13 shown in FIG. 2, the spaced-apart conductive coils 131, 133, 135 and 137 are arranged parallel to one another in a same first plane, the axes X₁, X₂, X₃ and X₄ being parallel and offset from one another in the common first plane. Like previously described, the conductive coils 131, 133, 135 and 137 can wind around their respective axes in successively alternating directions.

In the energizing coil assembly 15 shown in FIG. 2, the spaced-apart conductive coils 151, 153, 155 and 157 are likewise arranged parallel to one another in a same second plane, the axes Y₁, Y₂, Y₃ and Y₄ being parallel and offset from one another in the second plane. Moreover, the conductive coils 151, 153, 155 and 157 can wind around their respective axes in successively alternating or identical directions.

The first plane in which are arranged the conductive coils 131, 133, 135 and 137 can be parallel and offset from the second plane in which are arranged the conductive coils 151, 153, 155 and 157. Moreover, the conductive coils 131, 133, 135 and 137 can be respectively arranged in symmetric association with the conductive coils 151, 153, 155 and 157. As a result, the electromagnetic fields E2 respectively created between the conductive coils 131, 133, 135 and 137 and the conductive coils 151, 153, 155 and 157 can be distributed in multiple parallel planes that are respectively perpendicular to the two planes of the energizing coil assemblies 13 and 15. Aside the different spatial arrangement of the conductive coils, the circuit connections can be similar to the embodiment described previously with reference to FIG. 1.

With the architecture described previously, there is no need for the transmitting device 101 to increase the power voltage to effectively transfer power through a greater working distance D₂ to the receiving device 102. Accordingly, problems such as overheating and excessive voltage bias can be prevented.

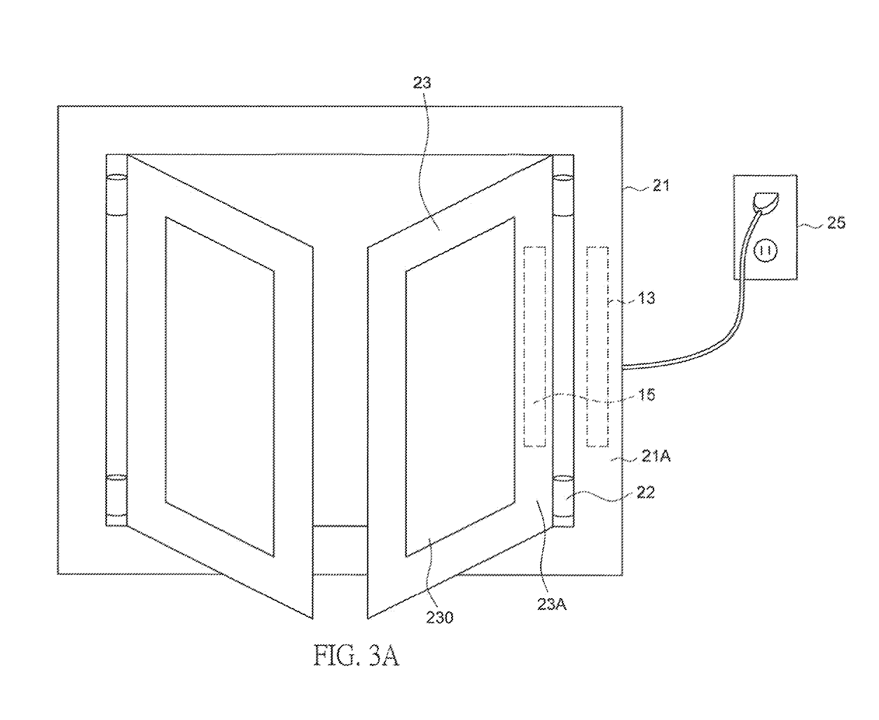

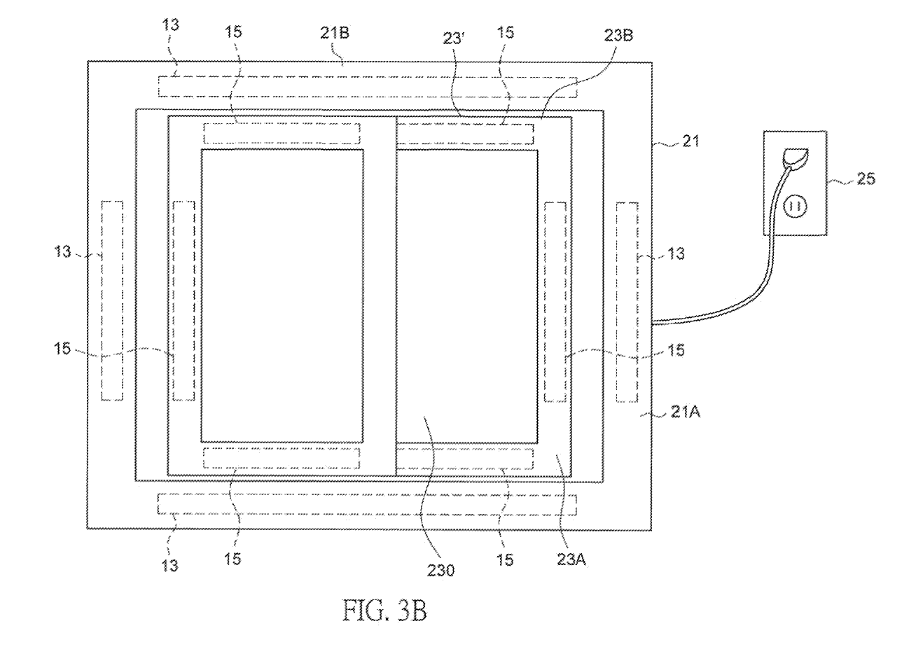

Having at least the aforementioned advantages, the contactless power transfer system described herein may be used in a variety of applications. FIG. 3A is a schematic view illustrating an embodiment in which the contactless power transfer system can be implemented for powering an electronic device used in a building structure, more specifically a building window structure. The building window structure can include a fixed opening frame 21, a movable frame 23 and a pivot axle 22. The movable frame 23 can be pivotally connected with a side edge 21A of the fixed opening frame 21 via the pivot axle 22. The movable frame 23 can be assembled with an electronic device 230. Examples of the electronic device 230 can include, without limitation, a display device, an electrically-powered mechanism, and the like.

The energizing coil assembly 13 described previously can be affixed with the side edge 21A of the fixed opening frame 21, and can be electrically connected with a power source 25 via a cable and plug assembly. In turn, the energizing coil assembly 15 can be affixed with the movable frame 23 at a side edge 23A near the side edge 21A of the fixed opening frame 21, and can be electrically connected with the electronic device 230. The energizing coil assemblies 13 and 15 can be respectively placed according to any of the spatial arrangements described previously with reference to FIGS. 1 and 2. The power source 25 can be electrically connected with the power source circuit 11, and the electronic device 230 installed with the movable frame 23 can be the electric load 17 of the power transfer system. Through inductive coupling between the energizing coil assemblies 13 and 15, power can be transferred in a contactless manner from the energizing coil assembly 13 to the electronic device 230 consuming power on the movable frame 23. Accordingly, no exposure of connection electrodes is needed on the electronic device 230 for power connection, which can improve its safety in use.

FIG. 3B is a schematic view illustrating another embodiment in which the contactless power transfer system can be implemented for powering an electronic device used in building structure having a sliding frame. One or more energizing coil assembly 13 can be affixed with different side edges 21A and 21B of the fixed opening frame 21 (e.g., the side edges 21A and 21B can be perpendicular to each other), and can be electrically connected with the power source 25 via a cable and plug assembly.

A sliding frame 23′ (e.g., a sliding door or window frame) can be assembled with a guide rail for horizontal displacement relative to the fixed opening frame 21. One or more energizing coil assembly 15 can be affixed with the sliding frame 23′ at side edges 23A and 23B (e.g., the side edges 23A and 23B can be perpendicular to each other) respectively near the side edges 21A and 21B of the fixed opening frame 21, and can be electrically connected with the electronic device 230. It is worth noting that the energizing coil assembly 13 installed at the side edge 21B can have a length that can encompass the width of two sliding frames 23′ so as to supply power to their respective energizing coil assembly 15. Through inductive coupling between the energizing coil assemblies 13 and 15, power can be transferred in a contactless manner from the energizing coil assembly 13 to the electronic device 230 on the sliding frame 23′.

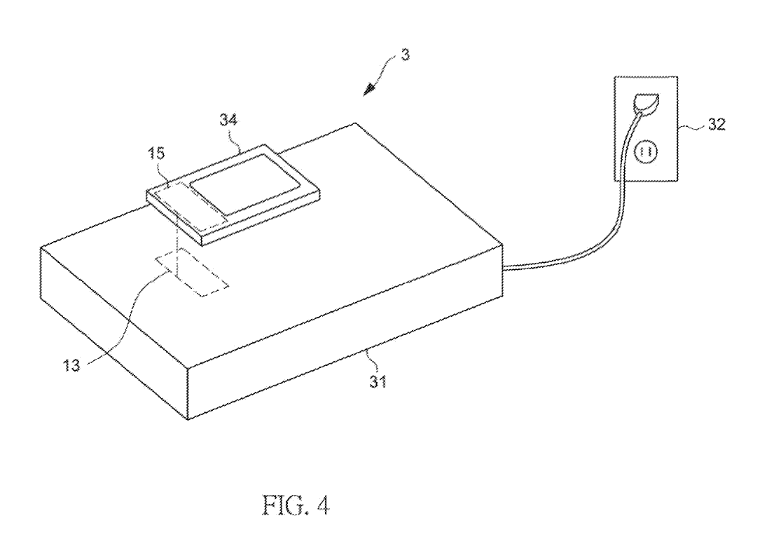

FIG. 4 is a schematic view illustrating yet another embodiment in which the contactless power transfer system can be implemented in a power charging system. The power charging system can include a charging apparatus 3 including a charging base 31. The energizing coil assembly 13 can be embedded in the charging base 31, and can be electrically connected with a power source 32 via a cable and plug assembly. In turn, the energizing coil assembly 15 can be embedded in a portable device 34, such as a tablet computer, a smart phone, a laptop computer and the like. The energizing coil assemblies 13 and 15 can be respectively placed according to any of the spatial arrangements described previously with reference to FIGS. 1 and 2. When the portable device 34 is placed on the charging base 31, power can be transferred in a contactless manner from the energizing coil assembly 13 to the portable device 34 through inductive coupling between the energizing coil assemblies 13 and 15 for charging the internal battery of the portable device 34. Accordingly, no exposure of connection electrodes is needed on any of the charging base 31 and the portable device 34 for power charging.

Advantages of the power transfer system described herein include the ability to prevent issues related to overheating and excessive power voltage bias on the conductive coils, which may occur in applications requiring greater working distances between the energizing coil assemblies. Accordingly, the power transfer system can be safer in use, and may be implemented in a wide range of applications.

Realizations of the power transfer systems have been described in the context of particular embodiments. These embodiments are meant to be illustrative and not limiting. Many variations, modifications, additions, and improvements are possible. These and other variations, modifications, additions, and improvements may fall within the scope of the inventions as defined in the claims that follow.

What is claimed is:

1. A transmitting device for transferring power to a receiving device through inductive coupling, the transmitting device comprising:
a power source circuit having a first and a second connection node;
a first conductive coil having a first and a second end; and
a second conductive coil arranged near the first conductive coil and having a third and a fourth end;
wherein the first and third ends are electrically connected with the first connection node, and the second and fourth ends are electrically connected the second connection node, the first and third ends and the first connection node being respectively applied with a same first voltage, and the second and fourth ends and the second connection node are respectively applied with a same second voltage.

2. The transmitting device according to claim 1, wherein the first conductive coil winds around a first magnetic conductor, and the second conductive coil winds around a second magnetic conductor, the first and second magnetic conductors being spaced apart from each other.

3. The transmitting device according to claim 1, wherein the first and second conductive coils respectively have a first and a second axis parallel to each other, and the first and second conductive coils respectively wind in opposite directions around the first and second axis.

4. The transmitting device according to claim 1, wherein the first and second conductive coils are coaxially aligned with each other about a common axis, and respectively wind in opposite directions around the common axis.

5. The transmitting device according to claim 1, wherein the first and second conductive coils respectively have a first and a second axis parallel to each other, the first and second axes being offset from each other.

6. A receiving device for receiving power from a transmitting device through inductive coupling, the receiving device comprising:
an electric load having a first and a second connection node;
a first conductive coil having a first and a second end; and
a second conductive coil arranged near the first conductive coil and having a third and a fourth end;
wherein the first and third ends are electrically connected with the first connection node, and the second and fourth ends are electrically connected the second connection node, the first and third ends and the first connection node being respectively applied with a same first voltage, and the second and fourth ends and the second connection node are respectively applied with a same second voltage.

7. The receiving device according to claim 6, wherein the first conductive coil winds around a first magnetic conductor, and the second conductive coil winds around a second magnetic conductor, the first and second magnetic conductors being spaced apart from each other.

8. The receiving device according to claim 6, wherein the first and second conductive coils respectively have a first and a second axis parallel to each other, and the first and second conductive coils respectively wind in opposite directions around the first and second axis.

9. The receiving device according to claim 6, wherein the first and second conductive coils are coaxially aligned with each other about a common axis, and respectively wind in opposite directions around the common axis.

10. The receiving device according to claim 6, wherein the first and second conductive coils respectively have a first and a second axis parallel to each other, the first and second axes being offset from each other.

11. A power transfer system suitable to transfer power through inductive coupling, the power transfer system comprising:
a power source circuit having a first and a second connection node;
a first energizing coil assembly including a first and a second conductive coil, the first conductive coil having a first and a second end, the second conductive coil having a third and a fourth end, wherein the first and third ends are electrically connected with the first connection node, and the second and fourth ends are electrically connected with the second connection node, the first and third ends and the first connection node being respectively applied with a same first voltage, and the second and fourth ends and the second connection node being respectively applied with a same second voltage;
an electric load having a third and a fourth connection node; and
a second energizing coil assembly including a third and a fourth conductive coil, the third and fourth conductive coils being respectively coupled inductively with the first and second conductive coils, the third conductive coil having a fifth and a sixth end, the fourth conductive coil having a seventh and an eighth end, wherein the fifth and seventh ends are electrically connected with the third connection node, and the sixth and eighth ends are electrically connected with the fourth connection node, the fifth and seventh ends and the third connection node being respectively applied with a same third voltage, and the sixth and eighth ends and the fourth connection node being respectively applied with a same fourth voltage;
wherein the first and second energizing coil assemblies are inductively coupled with each other to supply power to the electric load.

12. The power transfer system according to claim 11, wherein the first, second, third and fourth conductive coil respectively wind around a first, a second, a third and a fourth magnetic conductor.

13. The power transfer system according to claim 11, wherein the first and second conductive coils respectively have a first and a second axis parallel to each other, the third and fourth conductive coils respectively have a third and a fourth axis parallel to each other, the first and second conductive coils respectively winding in two opposite directions around the first and second axes, and the third and fourth conductive coils respectively winding in two opposite directions around the third and fourth axes.

14. The power transfer system according to claim 11, wherein the first and second conductive coils are coaxially aligned with a first axis and respectively wind in opposite directions around the first axis, and the third and fourth conductive coils are coaxially aligned with a second axis and respectively wind in opposite directions around the second axis.

15. The power transfer system according to claim 11, wherein the first and second conductive coils respectively have a first and a second axis parallel to each other, and the third and fourth conductive coils respectively have a third and a fourth axis parallel to each other, the first axis being offset from the second axis, and the third axis being offset from the fourth axis.

16. The power transfer system according to claim 11, wherein the first and second conductive coils are symmetrically arranged with respect to the third and fourth conductive coils.

17. The power transfer system according to claim 11 being implemented in a building window structure, the building window structure including a fixed opening frame and a movable frame pivotally assembled with the opening frame, wherein the first energizing coil assembly is assembled with the opening frame, and the second energizing coil assembly and the electric load are respectively assembled with the movable frame.

18. The power transfer system according to claim 11 being implemented in a building structure, the building structure including a fixed opening frame and a movable frame assembled with the opening frame, the movable frame being operable to slide relative to the opening frame, wherein the first energizing coil assembly is assembled with the opening frame, and the second energizing coil assembly and the electric load are respectively assembled with the sliding frame.

19. The power transfer system according to claim 11 being implemented in a power charging system, the power charging system including a charging apparatus and a portable device, wherein the first energizing coil assembly is embedded in a charging base of the charging apparatus, and the second energizing coil assembly is embedded in the portable device.
